(19) United States
(12) Patent Application Publication
(10) Pub. No.: US 2025/0178370 A1
(43) Pub. Date: Jun. 5, 2025

(54) SYSTEM AND METHOD OF USING PLANCHETTES AND MICROPRINTING TO DETECT UNAUTHORIZED COPYING OR COUNTERFEITING IN ARTICLES OF MANUFACTURE

(71) Applicant: The Government of the United States of America, as represented by the Secretary of Homeland Security, Washington, DC (US)

(72) Inventors: Joel Zlotnick, Arlington, VA (US); Tyra McConnell, Knoxville, MD (US); Traci Moran, Rockville, MD (US); Jordan Brough, Leesburg, VA (US); Troy Eberhardt, Centreville, VA (US); Elizabeth Gil, Bristow, VA (US)

(73) Assignee: The Government of the United States of America, as represented by the Secretary of Homeland Security, Washington, DC (US)

(21) Appl. No.: 19/047,275

(22) Filed: Feb. 6, 2025

Related U.S. Application Data
(62) Division of application No. 18/102,002, filed on Jan. 26, 2023.
(60) Provisional application No. 63/313,178, filed on Feb. 23, 2022.

(51) Int. Cl. B41M 3/14; B42D 25/20; B42D 25/355; B42D 25/387

(52) U.S. Cl. CPC B41M 3/14; B42D 25/20; B42D 25/355; B42D 25/387

(57) ABSTRACT

A security system for an article of manufacture includes: one or more first planchettes included in the article of manufacture and configured to luminesce when a first frequency of light is directed to the one or more first planchettes; and one or more second planchettes included in the article of manufacture and configured to luminesce when a second frequency of light is directed to the one or more second planchettes. The first and second planchettes have one or more first planchette substrates each including a first planchette surface having a first UV-reactive microprinting thereon; and one or more second planchette substrates each including a second planchette surface having a second UV-reactive microprinting thereon. The first UV-reactive microprinting is different from the second UV-reactive microprinting.

### CROSS-REFERENCE TO RELATED APPLICATIONS

This is a divisional of U.S. patent application Ser. No. 18/102,002, filed on Jan. 26, 2023, which is a nonprovisional application that claims the benefit of priority from U.S. Provisional Application No. 63/313,178 entitled “Systems and Methods of Using Planchettes to Detect Unauthorized Copying or Counterfeiting in Articles of Manufacture,” filed on Feb. 23, 2022, the entire disclosures of which are incorporated herein by reference.

### STATEMENT OF GOVERNMENT INTEREST

The claimed subject matter was made by one or more employees of the United States Department of Homeland Security in the performance of official duties. The U.S. Government has certain rights in this invention.

### FIELD

The present subject matter relates generally to the field of security, and more specifically to the use of planchettes as security features in documents and other printed products.

### BACKGROUND

One of the most common and effective strategies for making paper products difficult to replicate is using security fibers. Security fibers are materials that are added during the paper manufacturing process. Fibers are a cost-effective security method that has been used for decades. Because they can be embedded into the paper document, they are virtually impossible to remove without damaging the paper itself. The distribution of the fibers is also visibly random in the paper.

Fiber can also be added to plastics, coatings, nonwovens, and other applications. The fibers can add another level of anti-counterfeiting technology. These fibers can be seen as a decorative feature to the unsuspecting eye, but they can expose fake products under examination.

There are several kinds of security fibers, all of which behave differently in printed products to bolster the fraud protection strategy. Light-sensitive fibers can be designed to fluoresce under different wavelengths of light. UV-reactive fibers are the most common. They light up underneath UV light. Fibers can also be designed to be visible or invisible in daylight. As such, fibers can be invisible and only fluoresce when exposed to UV light. Temperature-sensitive fibers can change colors when hot or cold temperatures are applied to the area. One common example of heat-sensitive fibers is a fingerprint-sensitive area of a check, where the paper darkens from white to red after one uses a fingertip to press or create friction (and therefore heat) against the paper. Both types of material can be visible or invisible fibers that can only be detected by light or heat. Other examples may involve color changes from opaque to clear. Document security applications include not only thermochromic but also photochromic and metameric. As with thermochromic, it is generally understood that photochromic and metameric are associated with inks, but similar effects could be associated with security fibers or planchettes.

Security fibers can be integrated into a variety of paper or mixed-material documents. Common and well-known examples include government products such as banknotes and passports, but security fibers are also found in checks, anti-counterfeiting labels, packaging, plastics, lottery tickets, stamps, and nonwovens. During the manufacturing process, security fibers can be a certain diameter and/or cross-sectional shape and can be cut to any desired length and embedded and dispersed into the material. While most fibers are rayon, nylon, or cotton, other materials may be used.

Prior work on security fiber optimization explored security fiber characteristics and combinations of diverse security fiber types together in one substrate.

### SUMMARY

Planchettes are cellulose-based tiny disks or round elements of, for example, about 1.6 mm in size. They are similar to security fibers in many respects, except for their shape and size. Planchettes can be optimized as distinct security substrates separate from the paper of the host document. Besides being easier to see, planchettes can be carriers for security fibers, and their surfaces are large enough to accept printed images. This provides options for customizing planchettes through graphic design strategies typically associated with static printed artwork. Planchettes may be visible in daylight to the naked eye, fluorescent, phosphorescent under UV light, thermochromic, or reactive. They may be visible in one color and can be combined with an invisible fluorescent color that is revealed under UV such as a 365 nm UV lamp. Most planchettes seem intended for reflected or UV light inspection, though they can be hard to inspect in reflected or UV light when embedded inside of (and concealed by) the document substrate. Accordingly, designing planchettes for transmitted light inspection may both overcome this limitation and facilitate new security roles for planchettes.

A security system for an article of manufacture may comprise: a first set of planchettes configured to luminesce when a first frequency of light is cast on the first planchettes; and a second set of planchettes configured to luminesce when a second frequency of light is cast on the first planchettes. A camera or a sensor may detect whether the planchettes are reflecting back a specific color or pattern. A computer may be programmed to use data from the camera or sensor to decide whether the article of manufacture is genuine or counterfeit.

In accordance with another aspect, a method of detecting whether an article of manufacture is authentic or genuine comprising: performing chemical ionization mass spectrometry on an article of manufacture; detecting whether a certain frequency of light is detected by a chemic mass spectrometer; if the certain frequency of light is detected, determining that the article of manufacture contains a planchette; determining the article of manufacture is genuine if the article of manufacture is determined to contain a planchette.

A method of scanning a planchette may comprise steps such as: illuminating the planchette with a specific frequency of light (or range of frequencies of light); capturing an image of the planchette with a camera; and storing the image or a hash of the image of the planchette. In some methods, there is no camera or sensor used. Light may be cast or shone onto the planchette to illuminate or reveal parts of the planchette not normally visible with reflected light (e.g., room-base lighting).

A method of manufacturing an article of manufacture (such as a security card) may comprise: attaching a first set of planchettes to the security card wherein the first set of planchettes reflect a specific pattern when they are illuminated with a light source at a specific frequency; attaching a second set of planchettes to the security card wherein the second set of planchettes reflect a different pattern at the same frequency; determining the article of manufacture is a counterfeit unless the first and second sets of planchettes are visible. The planchettes may be manufactured such that they must be illuminated at a specific angle (e.g., coaxially) in order for the pattern to be visible or luminesce.

Another example might be: a method of manufacturing an article of manufacture (such as a $100 dollar bill) may comprise: incorporating a first set of planchettes in the dollar bill (the banknote substrate) wherein the first set of planchettes reflect a specific color when they are illuminated with a light source at a specific frequency; incorporating a second set of planchettes in the dollar bill wherein the second set of planchettes reflect a different color at the same frequency; determining the article of manufacture is a counterfeit unless both sets of planchettes are visible. The method may involve a human looking at the dollar bill to determine whether the planchettes are visible. Alternatively, a camera or a sensor may detect whether the planchettes are reflecting back a specific color or pattern. A computer may be programmed to use data from the camera or sensor to decide whether the article of manufacture is genuine or counterfeit.

A security system for an article of manufacture may comprise: a first set of planchettes configured to luminesce when a first frequency of light is cast on the first planchettes; and a second set of planchettes configured to luminesce when a second frequency of light is cast on the first planchettes. The first frequency may be different from the second frequency. The first and second set may comprise one planchette or a plurality of planchettes. The first set of planchettes may be configured so that they only luminesce when light of a first specific frequency is cast on the planchettes. The second set of planchettes may be configured so that they only luminesce when light a second specific frequency is cast on the planchettes.

In accordance with an aspect of the present invention, a security system for an article of manufacture comprises: one or more first planchettes included in the article of manufacture and configured to luminesce when a first frequency of light is directed to the one or more first planchettes; and one or more second planchettes included in the article of manufacture and configured to luminesce when a second frequency of light is directed to the one or more second planchettes. The one or more first planchettes and the one or more second planchettes having at least one of the following characteristics: (i) the first frequency is different from the second frequency, the one or more first planchettes are configured not to luminesce when the second frequency of light is directed to the one or more first planchettes, and the one or more second planchettes are configured not to luminesce when the first frequency of light is directed to the one or more second planchettes; (ii) the one or more first planchettes are configured to luminesce at a first color when the first frequency of light is directed to the one or more first planchettes, and the one or more second planchettes are configured to luminesce at a second color different from the first color when the second frequency of light is directed to the one or more second planchettes; or (iii) the one or more first planchettes are configured to reflect a first pattern when the first frequency of light is directed to the one or more first planchettes, and the one or more second planchettes are configured to reflect a second pattern when the second frequency of light is directed to the one or more second planchettes.

In some embodiments, the first frequency of light is same as the second frequency of light under the characteristic (ii). The first frequency of light is same as the second frequency of light under the characteristic (iii). The one or more first planchettes are configured to reflect the first pattern when the first frequency of light is directed to the one or more first planchettes at a first angle, and the one or more second planchettes are configured to reflect the second pattern when the second frequency of light is directed to the one or more second planchettes at a second angle, under the characteristic (iii). At least one of the first frequency of light or the second frequency of light may be a UV light frequency.

In specific embodiments, the one or more first planchettes are configured to luminesce when the first frequency of light is directed to the one or more first planchettes at a first angle. The one or more second planchettes are configured to luminesce when the second frequency of light is directed to the one or more second planchettes at a second angle.

In some embodiments, the first and second planchettes comprise at least one of (i) a plurality of first planchettes embedded at different depths of the article of manufacture exhibiting different levels of visibility when the first frequency of light is directed to the first planchettes; or (ii) a plurality of second planchettes embedded at different depths of the article of manufacture exhibiting different levels of visibility when the frequency of light is directed to the second planchettes.

In specific embodiments, the first and second planchettes comprise at least one of (i) one or more first planchettes composed of a first iridescent material; or (ii) one or more second planchettes composed of a second iridescent material.

In some embodiments, the first and second planchettes comprise at least one of (i) one or more first planchette substrates including at least one of first pigments incorporated therein, first surface printing thereon, or first security fibers incorporated therein; or (ii) one or more second planchette substrates including at least one of second pigments incorporated therein, second surface printing thereon, or second security fibers incorporated therein.

In specific embodiments, the first and second planchettes comprise at least one of (i) one or more first planchette substrates including first security fibers incorporated therein, the one or more first planchette substrates and the first security fibers having different UV responses; or (ii) one or more second planchette substrates including second security fibers incorporated therein, the one or more second planchette substrates and the second security fibers having different UV responses.

In some embodiments, the first and second planchettes comprise at least one of (i) one or more first planchette substrates including first security fibers incorporated therein, the first security fibers containing a first UV-reactive microprinting; or (ii) one or more second planchette substrates including second security fibers incorporated therein, the second security fibers containing a second UV-reactive microprinting. If a security fiber is tiny compared to the size of a planchette, then printed text applied to the edge of a fiber (not the planchette surface) might be so small as to be described as nanoprinting.

In specific embodiments, the first and second planchettes comprise at least one of (i) one or more first planchette substrates each including a first planchette surface having a first UV-reactive microprinting thereon; or (ii) one or more second planchette substrates each including a second planchette surface having a second UV-reactive microprinting thereon.

In some embodiments, the first and second planchettes comprise at least one of (i) a plurality of first planchette substrates including a plurality of first planchette surfaces on which a first UV-reactive microprinting is placed, placement of the microprinting being different for each of the plurality of first planchette substrates in relation to a first planchette edge of each first planchette surface of the plurality of first planchette surfaces; or (ii) a plurality of second planchette substrates including a plurality of second planchette surfaces on which a second UV-reactive microprinting is placed, placement of the microprinting being different for each of the plurality of second planchette substrates in relation to a second planchette edge of each second planchette surface of the plurality of second planchette surfaces.

In specific embodiments, the first and second planchettes comprise at least one of (i) one or more first planchette substrates each having printed work on a first planchette surface oriented to be invisible in reflected light and be visible in transmitted light; or (ii) one or more second planchette substrates each having printed work on a second planchette surface oriented to be invisible in reflected light and be visible in transmitted light.

In some embodiments, the first and second planchettes comprise at least one of (i) one or more first planchette substrates each having printed work on a first planchette surface oriented to be invisible in reflected light and be visible in transmitted light, the one or more first planchette substrates being same in color as the article of manufacture; or (ii) one or more second planchette substrates each having printed work on a second planchette surface oriented to be invisible in reflected light and be visible in transmitted light, the one or more second planchette substrates being same in color as the article of manufacture.

In accordance with another aspect, a method of detecting whether an article of manufacture is genuine comprises: directing a first frequency of light to the article of manufacture; directing a second frequency of light to the article of manufacture; detecting whether one or more first planchettes in the article of manufacture luminesce at the first frequency of light and whether one or more second planchettes in the article of manufacture luminesce at the second frequency of light having at least one of three characteristics: (i) the first frequency is different from the second frequency, the one or more first planchettes are configured not to luminesce when the second frequency of light is directed to the one or more first planchettes, and the one or more second planchettes are configured not to luminesce when the first frequency of light is directed to the one or more second planchettes; (ii) the one or more first planchettes are configured to luminesce at a first color when the first frequency of light is directed to the one or more first planchettes, and the one or more second planchettes are configured to luminesce at a second color different from the first color when the second frequency of light is directed to the one or more second planchettes; or (iii) the one or more first planchettes are configured to reflect a first pattern when the first frequency of light is directed to the one or more first planchettes, and the one or more second planchettes are configured to reflect a second pattern when the second frequency of light is directed to the one or more second planchettes; and determining that the article of manufacture is genuine if the one or more first planchettes and the one or more second planchettes are detected in the article of manufacture having at least one of the three characteristics.

In accordance with another aspect of the invention, a system of detecting whether an article of manufacture is genuine comprises: a light source to direct light to the article of manufacture at a first frequency and at a second frequency; an image detector including non-transitory computer readable instructions stored on a tangible computer read storage medium, the instructions causing a microprocessor connected to the image detector to: detect whether one or more first planchettes in the article of manufacture luminesce at the first frequency of light and whether one or more second planchettes in the article of manufacture luminesce at the second frequency of light having at least one of three characteristics: (i) the first frequency is different from the second frequency, the one or more first planchettes are configured not to luminesce when the second frequency of light is directed to the one or more first planchettes, and the one or more second planchettes are configured not to luminesce when the first frequency of light is directed to the one or more second planchettes; (ii) the one or more first planchettes are configured to luminesce at a first color when the first frequency of light is directed to the one or more first planchettes, and the one or more second planchettes are configured to luminesce at a second color different from the first color when the second frequency of light is directed to the one or more second planchettes; or (iii) the one or more first planchettes are configured to reflect a first pattern when the first frequency of light is directed to the one or more first planchettes, and the one or more second planchettes are configured to reflect a second pattern when the second frequency of light is directed to the one or more second planchettes; and determine that the article of manufacture is genuine if the one or more first planchettes and the one or more second planchettes are detected in the article of manufacture having at least one of the three characteristics.

Other features and aspects will become apparent from the following detailed description, which taken in conjunction with the accompanying drawings illustrate, by way of example, the features in accordance with embodiments of the claimed subject matter. This summary is not intended to identify key or essential features of the claimed subject matter, nor is it intended to limit the scope of the claimed subject matter, which is defined solely by the claims attached hereto.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

One or more example embodiments of the subject matter are described in detail with reference to the following drawings. These drawings are provided to facilitate understanding of the present subject matter and should not be read as limiting the breadth, scope, or applicability thereof. For purposes of clarity and ease of illustration, these drawings are not necessarily made to scale.

FIG. 1 illustrates examples of possible planchette edge contours, including round (left) and hexagonal (center) planchettes and long, flat, rectangular security fibers that are large enough to be treated as planchettes (right).

FIG. 2 illustrates examples of round planchettes of various reflected light colors, including red, blue, and yellow.

FIG. 3 illustrates the same examples of round planchettes as in FIG. 2 but illuminated in UV light.

FIG. 4 illustrates an example of an invisible UV-responsive planchette.

FIG. 5 illustrates an example of planchettes containing high densities of blue security fibers (left), or a mix of red and blue security fibers (center and right).

FIG. 6 illustrates the same planchettes as in FIG. 5 but illuminated with UV.

FIG. 7 illustrates an example of a hexagonal planchette composed of iridescent material instead of paper.

FIG. 8 illustrates an example of printed artwork on the surface of a planchette which, in reflected light, is visible but the planchette substrate cannot be seen because it is the same color as the document substrate.

FIG. 9 illustrates an example of a large, flat security fiber containing UV-reactive microprinting text.

FIG. 10 illustrates an example of UV-reactive microprinting similar to the example shown in FIG. 9, as applied to the surface of a planchette instead of a security fiber.

FIG. 11 illustrates an example of UV-reactive microprinting in three planchettes in the same passport, where the placement of the microprinting in relation to the planchette edge is different for each.

FIG. 12 illustrates an example of a mockup of fine stripes printed on the surface of a substrate (left) and on hexagonal planchettes that could be punched from the substrate (right).

FIG. 13 illustrates an example of a mockup of microprinting printed on the surface of a substrate (left) and on hexagonal planchettes that could be punched from the substrate (right).

FIG. 14 illustrates an example of visible planchettes at different depths within the 3D structure of a paper substrate.

FIG. 15 illustrates an example of the same invisible UV-reactive planchette shown in FIG. 10 (showing UV-reactive microprinting as applied to the surface of the planchette), as it would be inspected without UV light.

FIG. 16 illustrates an example of a planchette containing printed artwork on its surface, similar to that shown in FIG. 8, but the planchette in FIG. 16 is upside down and the artwork is concealed as photographed in reflected light in the left image.

FIG. 17 illustrates an example of a mockup of microprinting printed in opaque white ink, or another ink color that matches the substrate color in reflected light.

FIG. 18 illustrates an example of a security thread as viewed in transmitted light (left), reflected ultraviolet light (center) and transmitted UV light (right).

FIG. 19 illustrates an example of a transparent window in a polycarbonate passport data page as viewed in reflected light (left), reflected UV light (center), and transmitted UV light (right).

FIG. 20 is a schematic view illustrating image detection of planchettes included in an article of manufacture in a reflective configuration.

FIG. 21 is a schematic view illustrating image detection of planchettes included in an article of manufacture in a transmissive configuration.

FIG. 22 is a block diagram illustrating an example of an authentication system for an article of manufacture utilizing planchettes.

FIG. 23 illustrates an example of a computing system, or apparatus, including logic according to an embodiment.

These drawings are not intended to be exhaustive or to limit the subject matter to the precise form(s) disclosed. It should be understood that the present subject matter can be practiced with modification and alteration, and that the subject matter is limited only by the claims and the equivalents thereof.

### DETAILED DESCRIPTION

As a security feature, planchettes can be hard to inspect in reflected or UV light when embedded inside of (and concealed by) the document substrate. The present disclosure explores designing planchettes for transmitted light inspection which may both overcome this limitation and facilitate new security roles for planchettes.

### Shape

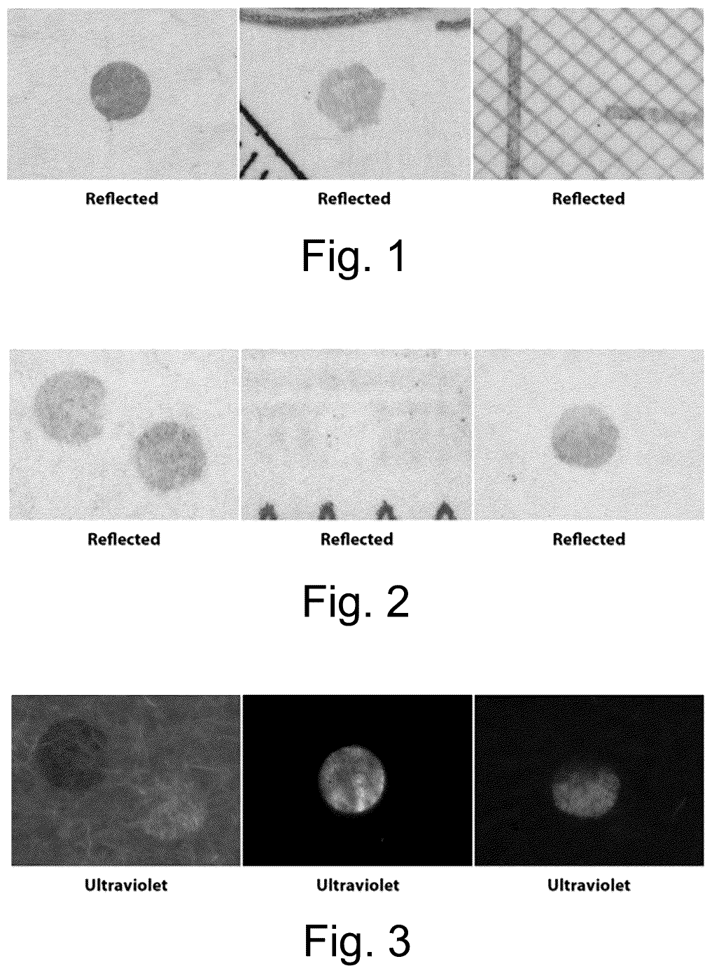

FIG. 1 illustrates examples of possible planchette edge contours, including round (left) and hexagonal (center) planchettes and long, flat, rectangular security fibers that are large enough to be treated as planchettes (right). Triangular, pentagonal, or other shapes could also be conceived. More exotic shapes/contours that cannot be described just as polygons may be possible, depending on manufacturing capabilities.

While the shape of a security fiber might be described as straight, curved, or wavy, planchettes have an edge contour that depends on how they are punched. Typical planchette shapes include round, hexagonal, and rectangular, as shown FIG. 1. More exotic planchette contours could include multiple shapes joined together, sawtooth or irregular edge patterns, interior cutouts within planchettes (e.g., an oval hole inside a triangular planchette), or many other possibilities. Not only would such planchettes need to be manufacturable themselves but would also have to be compatible with papermaking (or polymer extrusion) processes for the security substrates that contain them. Issuers and suppliers may come to different conclusions about what is possible and appropriate for their own document products.

### Color

FIG. 2 illustrates examples of round planchettes of various reflected light colors, including red, blue, and yellow. FIG. 3 illustrates the same examples of round planchettes as in FIG. 2 but illuminated in UV light. The visible colors of the planchettes in FIG. 2 can be compared to the UV responses of the same planchettes shown in FIG. 3.

Planchettes may or may not respond to UV, and for those that do the UV response may or may not be the same as the visible light color. As seen in FIG. 2 and FIG. 3, for example, the red planchette in the left image darkens in UV, but the red planchette in the right image glows blue, and in other documents red planchettes just glow red.

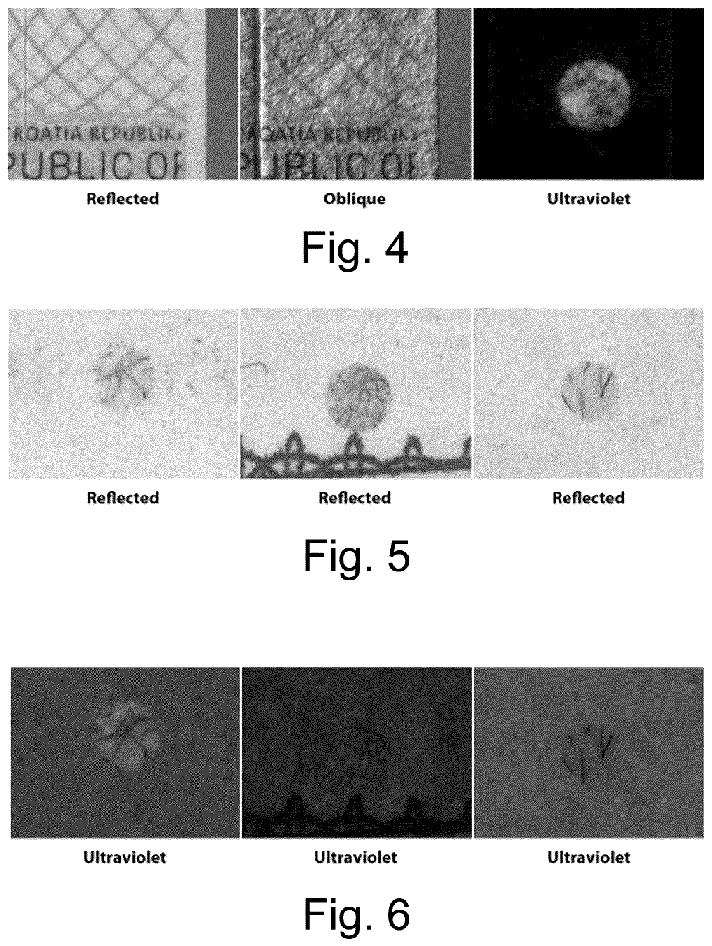

FIG. 4 illustrates an example of an invisible UV-responsive planchette. The planchette is invisible in reflected light (left) and it can be seen in oblique light (center) by those that know to look for it, but it really becomes visible only in UV. Invisible planchettes may be attractive from a design standpoint because they do not compete with visible art but offer limited security value because they require a UV light source for inspection.

Another important characteristic of planchettes is color, which can mean different things: the color of a planchette substrate in visible and/or ultraviolet (UV) light, the visible and/or UV color(s) of security fibers embedded in a planchette substrate, or the visible and/or UV color(s) of printed images on a planchette surface. Paper planchettes with various visible, invisible, UV bright, and UV dull color responses are shown in FIGS. 2 to 4, though more combinations are clearly possible. Most likely, the colors in FIGS. 2 to 4 were created by incorporating pigment in the planchette substrate, but surface printing is another way to color planchettes and is discussed further below. Which method is chosen may affect color saturation and contrast in transmitted light if higher amounts of pigment inside a planchette substrate may block light better than a thin surface printing, or the intensity of a UV response is improved if the UV pigment is on the planchette surface, etc.

Planchette “color” might also include specific infrared (IR) characteristics. This approach might apply in circumstances where visible planchettes could interfere with machine readability (in manufacturing quality control systems, passport readers, banknote processing equipment, etc.) but invisible planchettes with reflected or transmitted IR characteristics might not. Further, IR imaging might simply produce better captures than visible or UV light imaging for planchettes embedded inside the document substrate, where the planchette surfaces are concealed.

### Composition and Security Fibers

Paper planchette substrates can also incorporate security fibers, but with significantly different design conventions and goals as compared to security fibers added directly to a security document substrate. First, security fiber density is typically low throughout macro security substrates, but fiber density in a planchette substrate must be very high to ensure that every planchette contains a cluster of fibers when punched. Second, planchettes containing multiple fibers together can be easier for document users to locate than a single isolated security fiber due to their larger size and better visibility. Third, because the fibers are clustered, each planchette becomes a training tool that helps document users identify how many different fiber types are present in the planchette. In contrast, in typical security document substrates, users may have to search to locate even a single security fiber; when one is found, users still do not know whether other kinds of security fibers are also present throughout the substrate. Fourth, monochromatic security fibers added directly to security document substrates are randomly placed and unregistered. However, security fibers within an individual planchette are collectively bounded by, and therefore registered to, the planchette edge, other fibers, and the tint color of the planchette substrate. This disclosure omits a complete discussion of why this internal registration of several disparate color components is important, but generally, it can help a planchette resist certain methods of simulation.

FIG. 5 illustrates an example of planchettes containing high densities of blue security fibers (left), or a mix of red and blue security fibers (center and right). For instance, the fiber density is higher in a planchette substrate than in a full document substrate. The planchette substrate itself is also tinted pink in the center and right images. Although both examples at the center and right contain red and blue fibers, the quantities and sizes of fibers are different. These examples illustrate how a planchette substrate can be optimized independently of the larger security document substrate that contains it.

FIG. 6 illustrates the same planchettes as in FIG. 5 but illuminated with UV. Just as in visible light, the planchette substrate and any security fibers it contains are distinct elements and can be customized with different UV responses. The only UV response in this set is from the planchette substrate in the left image, which glows blue/white in UV, but other configurations of planchettes could incorporate other combinations of substrate and/or security fiber UV responses.

Examples of planchettes containing security fibers are shown in visible light in FIG. 5 and UV light in FIG. 6. These examples show how a planchette substrate can itself be optimized as an independent security substrate, with multiple substrate color properties and various security fiber combinations. As noted, designers and manufacturers have tremendous flexibility to customize across these variables.

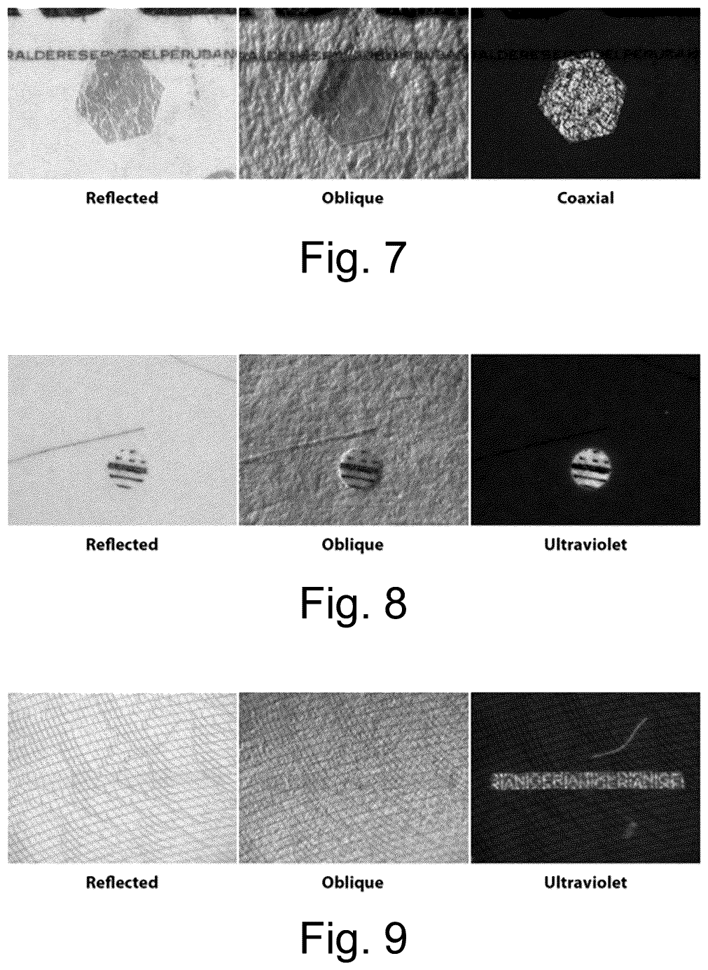

FIG. 7 illustrates an example of a hexagonal planchette composed of iridescent material instead of paper. In other applications, iridescent material can be printed or applied to the surface of a non-iridescent planchette substrate in the form of an image and/or coating. The color of the image changes depending upon the angle at which light hits the surface of the planchette. When tilted it produces a pearlescent effect that cannot be mimicked by CMYK (Cyan, Magenta, Yellow, Black), forcing many counterfeiters to undertake additional steps to simulate it. Metallic specular reflection, holographic, or other optical effects might also be possible, but tiny planchettes that are often covered by the substrate might not be optimal carriers for complex visual effects that are more easily added to other document components.

FIGS. 1 to 6 illustrate paper planchettes, but other planchette compositions can facilitate specific visual effects. For example, the plastic planchette in FIG. 7 is iridescent, but metallic, color shifting, holographic, or other visual effects might also be possible. The planchette in FIG. 7 is close to the substrate surface so that the iridescent effect is easy to see, but planchettes may not be ideal carriers for exotic visual effects that cannot be seen if a planchette is embedded inside the document substrate.

### Printed Artwork

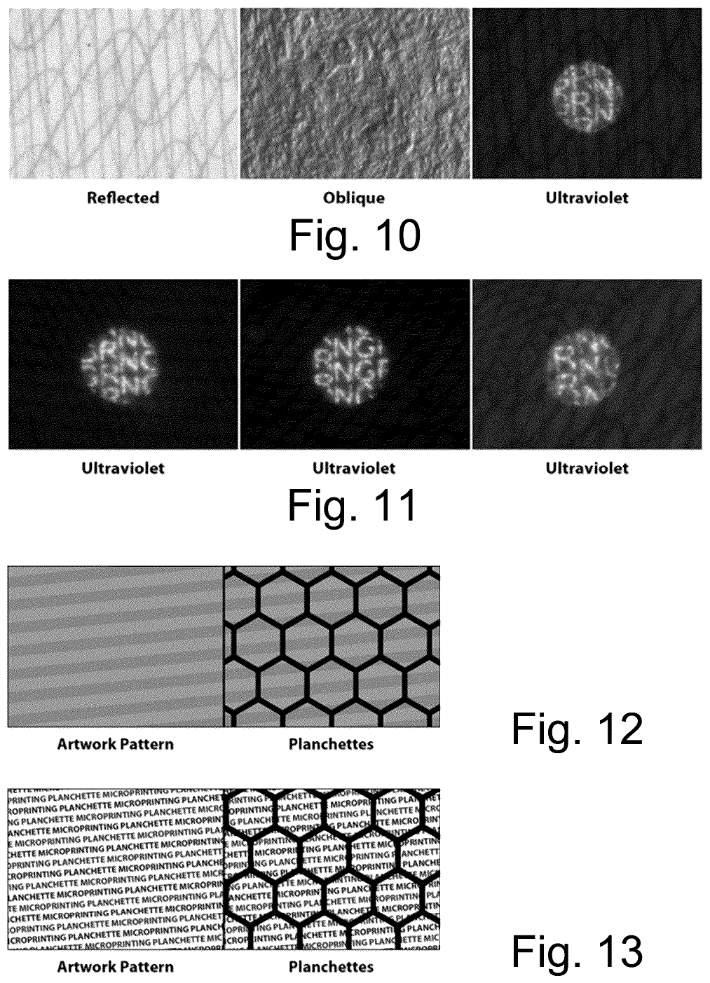

FIG. 8 illustrates an example of printed artwork on the surface of a planchette which, in reflected light, is visible but the planchette substrate cannot be seen because it is the same color as the document substrate. In oblique or UV light, both the artwork and the planchette substrate are visible. Both the artwork and the UV response are registered to the planchette edge, and therefore to one another. FIGS. 9 and 10 show the reverse examples: UV printing on a UV-dull planchette surface.

Compared to thin security fibers, the large size and flat shape of planchettes allow them to accept visible and/or UV-reactive printed images. For example, the planchette in FIG. 8 was punched from a substrate containing visible artwork and shows only a small part of a larger design. The planchette substrate is the same visible color as the document substrate and is hard to see in reflected light but glows yellow in UV. Importantly, the contour of the planchette edge defines where both the dark surface print and the substrate UV response are bounded, ensuring that these two characteristics are both registered to the planchette edge and, by extension, each other. Again, this internal registration of two different effects produces resistance to certain counterfeiter simulation methods. This planchette is close to the surface of the document substrate, but the reflected light visibility of the dark print would be reduced if it were deeper in the substrate.

FIG. 9 illustrates an example of a large, flat security fiber containing UV-reactive microprinting text. As compared to the invisible UV-reactive planchette substrate of FIG. 4, advantages of this format are that counterfeiting tiny microtext requires high resolution printing in addition to the UV ink, and the UV glow might help locate the fiber if it were embedded deep in the substrate. However, this could be a hard feature to inspect since it requires both magnification and UV light at the same time.

FIG. 10 illustrates an example of UV-reactive microprinting similar to the example shown in FIG. 9, as applied to the surface of a planchette instead of a security fiber. Similarly, the flat rectangular security fiber in FIG. 9 and the planchette in FIG. 10 each contain UV-reactive microprinting. This combination (planchette+microprinting+UV response) stands out in many ways. It randomly distributes microprinting throughout the document, which is not possible with static surface art. Further, a high-resolution counterfeiting technology that is also compatible with UV printing would be required to simulate the fine UV microprinting details, as opposed to the low-resolution macro color of a planchette substrate tint.

FIG. 11 illustrates an example of UV-reactive microprinting in three planchettes in the same passport, where the placement of the microprinting in relation to the planchette edge is different for each. That each planchette simultaneously shows similar art but different placement confers advantages against certain simulation strategies. Note the larger text in the right image; this may be an intentional variation within the larger microprinting pattern.

Finally, the microprinting placement on each fiber/planchette is unique in relation to the planchette edge even as the general microprinting pattern is recognizable between planchettes, as shown in FIG. 11. Planchettes with both static (artwork design) and variable (artwork placement) elements are conceptually analogous to security fibers of the same color, but random positioning in different documents and the random placement can present similar security advantages.

However, much like the invisible planchette in FIG. 4, document users are challenged to locate or inspect the UV print in FIGS. 9 to 11 without UV light. Further, UV microprinting is a combination of two second level security features that is complicated to inspect because it requires the simultaneous use of both magnification and UV light. Finally, the legibility of UV microprinting could easily be obscured if a fiber or planchette is embedded too deep in the document substrate, limiting the accessibility of the feature. Despite these limitations, such a strategy may still provide value if it is inexpensive to implement.

Planchettes punched from tinted substrates such as those in FIGS. 2 to 4 are monochromatic, and the printed images on the planchettes in FIGS. 8 to 11 are also monochromatic. However, multicolor effects could be achieved in non-tinted planchettes printed with multicolor artwork.

Multicolor microprinting design was described in prior work. See, e.g., U.S. patent application Ser. No. 17/961,951, filed Oct. 7, 2022, entitled MICROPRINTING TECHNIQUES FOR PRINTING SECURITY SYMBOLS ON A SUBSTRATE, which is incorporated herein by reference in its entirety. It is extendable to planchette microprinting art, though planchette art embedded inside the document substrate can be hard to see. Accordingly, in planchette contexts, artwork concepts should not necessarily be limited to microprinting because bolder multicolor designs with less fine detail might be easier to inspect.

FIG. 12 illustrates an example of a mockup of fine stripes printed on the surface of a substrate (left) and on hexagonal planchettes that could be punched from the substrate (right). Although the pattern is recognizably the same in each planchette, the specific placement of the stripes makes each planchette subtly unique. That the pattern is different for each planchette can offer advantages against certain types of planchette simulation attacks.

In FIG. 12, the hexagonal planchettes are punched from a substrate printed with parallel stripes of red and blue offset artwork, designed such that each planchette accommodates about four stripes. Each planchette shows the same general stripe pattern but the placement of the stripes relative to the edge is unique for each planchette. Because such subtle placement variations are unlikely to confuse document users that are just looking for stripes, manufacturers have no need to achieve precise register between the stripes and the location of the edge punch, and the variation introduced by this imperfect registration also conveys advantages. Diversity of art placement within a planchette is analogous to the random distribution of security fibers in a substrate and helps interrupt certain planchette simulation methods.

FIG. 13 illustrates an example of a mockup of microprinting printed on the surface of a substrate (left) and on hexagonal planchettes that could be punched from the substrate (right). As in FIG. 12, each planchette is unique but also looks generally like the others. This microprinting could be added at low cost and would require both good resolution and good registration to simulate, but if such a planchette were enclosed inside the document substrate the microprinting detail could be masked.

The mockup in FIG. 13 shows the same color pattern as FIG. 12 but with multicolor microprinting graphics instead of stripes. FIG. 13 is superior to FIG. 12 because simulating the microprinting details requires counterfeiters to use high-resolution printing processes. Yet it is also inferior because fine microprinting details could be more difficult for document users to check since planchettes are frequently concealed inside the document substrate. Issuers must determine their own priorities.

FIGS. 12 and 13 are simplistic mockups intended only to illustrate general concepts and should be extrapolated to capture benefits and avoid limitations of different approaches to planchette graphics. Some examples include more than two visible and/or UV colors, use of visible inks that also feature UV responses, alternating stripes or other shapes with microprinting or other fine graphics, dividing the microprinting colors within words (or even individual characters) instead of between lines, establishing color contrast between ink and fiber colors, and a variety of other combinations and considerations.

A final but important distinction between offset artwork design for full documents as opposed to planchettes is how repeating and nonrepeating artwork is used. Artwork, including simultaneous offset artwork, should be nonrepeating in macro document designs to prevent step-and-repeat counterfeiting. In contrast, repeating artwork may be desirable in substrates from which planchettes will be punched because it ensures each planchette captures a tiny piece of the same artwork pattern regardless of the location from which it is punched in the macro design. Because the placement of the artwork relative to the planchette edges varies, each specific planchette features its own unique artwork placement, making the artwork nonrepeating across a population of planchettes even if the source artwork is repeating. If fully nonrepeating artwork were included in a planchette substrate, the artwork patterns on two different planchettes might look significantly different from one another and could confuse users. Possibly, a compromise between repeating and nonrepeating art could also be used for planchette artwork design where artwork variation is more subtle than in macro document designs.

### Designing for Transmitted Light

As discussed in prior examples, a problem in planchette design is that planchettes may be located at any depth within the document substrate. In reflected light, the document substrate may conceal the color of a planchette substrate or the details of any visible printing or special visual effects on the planchette surface. The document substrate may also prevent incident UV from reaching planchette components such as UV-reactive security fibers or UV-reactive artwork or may mask the visible fluorescence of these components.

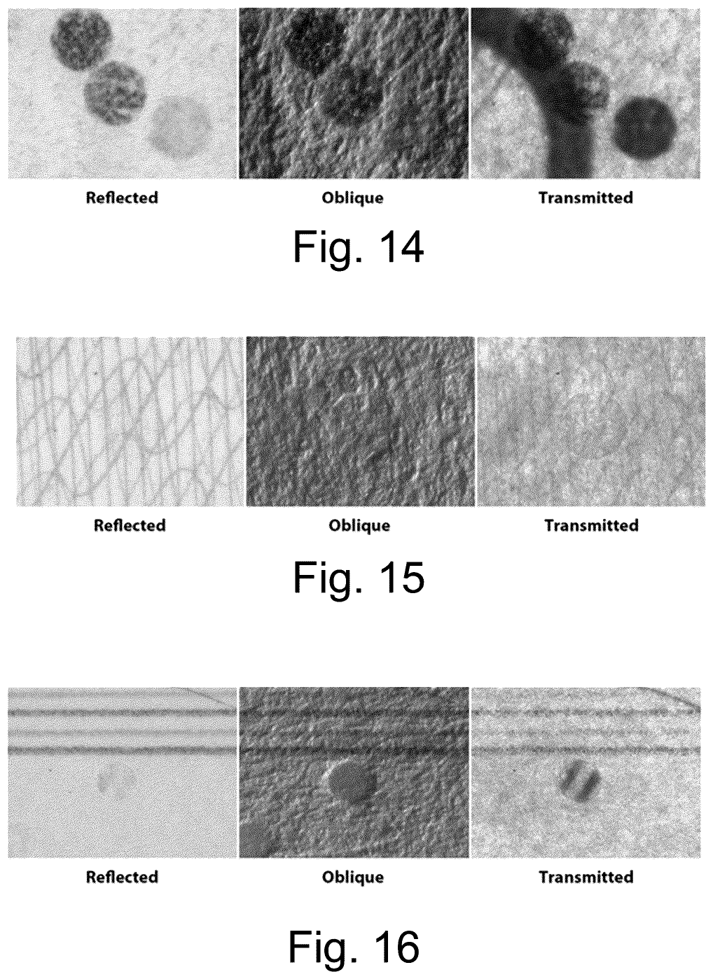

FIG. 14 illustrates an example of visible planchettes at different depths within the 3D structure of a paper substrate. The planchette at the lower right is deeper within the substrate than the two at the left, so it is barely visible in reflected and oblique light. In transmitted light, all three planchettes can be easily seen since all block light similarly regardless of their placement in the substrate. Planchettes are not typically optimized for transmitted light inspection, but this is an area with potential for further development.

For example, FIG. 14 shows how reflected light visibility of a planchette with a tinted substrate is dependent on its depth within the document substrate but transmitted light examination can make planchette colors generally more visible regardless of whether their surfaces are concealed.

FIG. 15 illustrates an example of the same invisible UV-reactive planchette shown in FIG. 10 (showing UV-reactive microprinting as applied to the surface of the planchette), as it would be inspected without UV light. Without UV, this planchette is likely to be overlooked unless one already knows it is present and to check for it. Nonetheless, this example provides a mechanism to introduce randomly distributed artwork to documents that can be expanded beyond UV applications. One may consider how the characteristics of this planchette affect user ergonomics and the utility of the feature. In contrast, non-tinted planchette substrates containing no visible artwork are all but invisible in reflected and transmitted light, as shown in FIG. 15.

FIG. 16 illustrates an example of a planchette containing printed artwork on its surface, similar to that shown in FIG. 8, but the planchette in FIG. 16 is upside down and the artwork is concealed as photographed in reflected light in the left image. In transmitted light, the artwork on the opposite side of the planchette can be seen as it blocks light. In reflected or transmitted light, the color of the planchette substrate is similar to or same as the color of the document substrate, and blends in. One may consider how these characteristics affect user ergonomics.

Even non-tinted planchette substrates containing visible artwork may be hard to locate or inspect in reflected light if the visible artwork is on the reverse of the planchette, as shown in FIG. 16.

The planchettes in FIGS. 14 and 16 are more consistently visible in transmitted light than they are in reflected light. Accordingly, even though planchettes are not typically regarded as a transmitted light feature, planchette designs could be optimized specifically for transmitted light inspection to help overcome the limitations caused by planchette embedment inside the document substrate. As just one example, if simultaneous offset technology were used to print identical registered images on the front and back of planchette substrates, transmitted light contrast could be maximized.

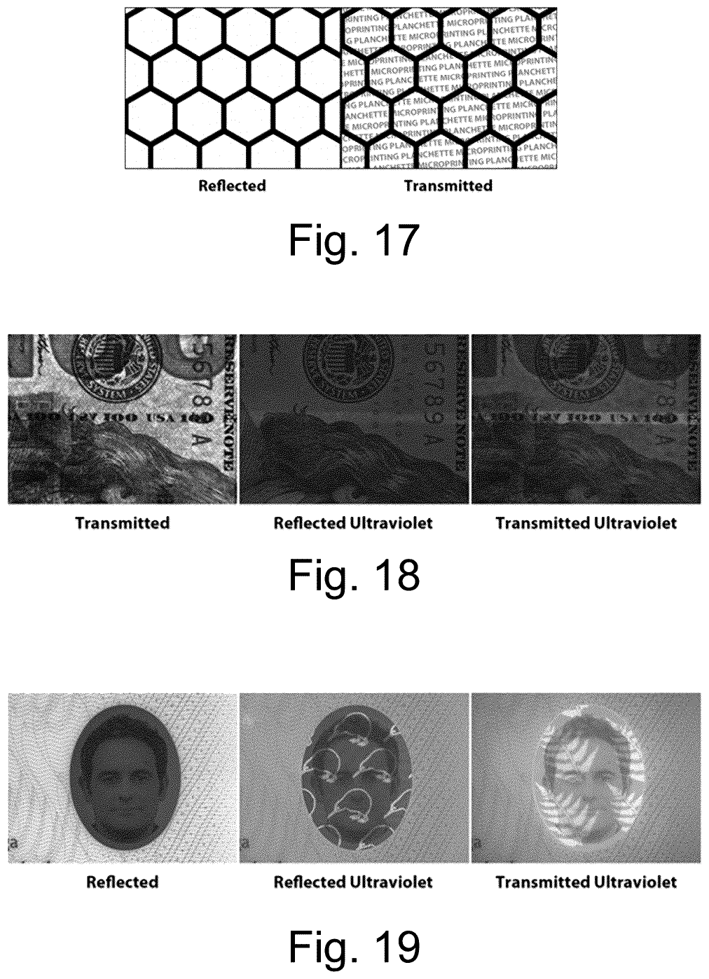

FIG. 17 illustrates an example of a mockup of microprinting printed in opaque white ink, or another ink color that matches the substrate color in reflected light. In reflected light, the printed artwork shows low contrast with the substrate surface and is nearly invisible, but in transmitted light the ink blocks light. Whether microprinting is best for this application is debatable since tiny details may be lost due to substrate interference, but other art could be used. One may consider combining this strategy with simultaneous offset.

Prior work has discussed simultaneous offset, which is the ability of certain security offset printing presses to apply images in register on opposite sides of a substrate. See, e.g., U.S. patent application Ser. No. 17/962,053, filed Oct. 7, 2022, entitled OFFSET PRINTING OF SECURITY SYMBOLS ON A SUBSTRATE, which is incorporated herein by reference in its entirety. Some concepts from the simultaneous offset series could be adapted to planchette design, including the use of opaque white inks as shown in FIG. 17 (or other specialty inks, such as metallics) as just one of many possible examples. In the case of white ink artwork (text, stripes, etc.) printed on a planchette substrate of the same color as the document substrate, the planchette has no reflected light characteristics and would occupy a new niche in the security feature landscape: a native transmitted light feature featuring high-resolution printed images that is also randomly distributed throughout the document substrate. One may consider how such a planchette could complement colored security fibers and planchettes and conventional transmitted light features such as watermarks and security threads.

FIG. 18 illustrates an example of a security thread as viewed in transmitted light (left), reflected ultraviolet light (center) and transmitted UV light (right). In transmitted light and transmitted UV light, metallized elements of the security thread block light and appear as dark text. In reflected ultraviolet light, the metallized text enclosed within the security thread cannot block light and is not visible. This security thread example might be extrapolated to planchettes that encompass reflected, UV and transmitted light inspection.

Just as FIG. 7 illustrates a polymer planchette with iridescent characteristics that allow it to be inspected by tilt in reflected light, polymer planchette substrates optimized for transmitted light inspection could be conceived. Suppose such a planchette substrate were composed of clear polymer, with opaque graphics in the style of security threads similar to the one shown in FIG. 18. Clear polymer planchettes might also facilitate UV light inspection, where the visible response is the same color regardless of UV source placement. However, one may consider clear planchettes where the UV response changes depending on whether UV is incident on the front or back of the planchette.

FIG. 19 illustrates an example of a transparent window in a polycarbonate passport data page as viewed in reflected light (left), reflected UV light (center), and transmitted UV light (right). The multilayer substrate construction is complex and includes multiple printed UV features and substrate layers that block UV light, resulting in different artwork depending on whether UV originates from the front or back. One may consider whether this concept could be adapted from this thick multilayer window structure to a thin transparent planchette.

FIG. 19 shows an example of this technique integrated into a clear window in a polycarbonate passport data page. The technique might be adapted to planchette design, though the thickness of a data page window and a planchette are very different, which could impact manufacturability.

Planchettes can be embedded into an article of manufacture to help prevent counterfeiting or unauthorized copying of that medium or object. An article of manufacture may include a medium or an object. A medium can be an item such as a document, a license, a passport, paper currency, a baseball card, etc. Planchettes can also be embedded into an object. Objects can include items such as dolls, furniture, jewelry, household goods, computer parts, or other physical, tangible items.

Methods of embedding the planchette into the medium may include printing, attaching, installing, forming in, or inserting. The medium or object may be generated, created, manufactured, assembled, or made with the planchette during manufacture, or the planchette may be added, attached, embedded, etc. after the article of manufacture was created.

Planchettes may be generated in different shapes such as ovals, circles, rectangles, triangles, hexagons, and other shapes. Planchettes may have a length and width greater than the depth. For example, a “disc-shaped” planchette may be circular and the depth may be smaller than the diameter (e.g., a flat shape).

A medium may have sufficient value such that a third party would want to make a counterfeit or unauthorized copy of the medium. The value may be realized directly such as a $20 bill. Alternatively, the medium may have value by providing access to a location or because it serves as a form of identification. Mediums such as a security badge, passport, or driver's license may provide both identification and access.

Embedding a planchette or plurality of planchettes into a medium or object may be part of a security system to prevent counterfeiting or unauthorized copying of the medium or object. In some cases, multiple planchettes may be embedded into the medium or object. The planchettes may be dispersed in a unique pattern or orientation or placed in an unusual location. For example, a grid of 50 locations may be selected for embedding the planchettes. A plurality of planchettes can be added to the grid (e.g., at least 5 but less than 45 planchettes). The plurality of planchettes can form a symbol, wherein the presence and absence of planchettes form the symbol. In some configurations, identical planchettes may be used to form the symbol, or the symbol may be composed of different color planchettes or planchettes with different patterns (stripes, dotes, dashes, etc.). The plurality of different patterns may compose the symbol or merely the presence or absence of a planchette in a particular location on the medium or object. The symbol composed on the planchettes may be an identifier or unique identifier (e.g., a serial number or code). The symbol may be associated with a specific medium or object, a date or location in which the medium or objected was manufactured, and/or a company producing or purchasing the medium or object.

As previously mentioned, embedding the planchette into the medium or object may be a part of a larger security system to prevent counterfeiting or unauthorized copying. For example, planchettes may be used with security fibers, specialty ink, and/or microprinting to make copying or counterfeiting more difficult.

Planchettes may be made by various processes. A planchette may be punched or cut from a substrate. The substrate may be printed with a pattern, stripes, lettering, waves, etc. The substrate may contain printing on one, two, three, or more sides. Planchettes may also be formed individually using techniques such as mold-based casting.

Planchettes in a set of planchettes may be generated such that they have the same pattern on each planchette in the set. Alternatively, the pattern may be offset on each planchette so that the patterns are variations of each other.

Planchettes may include a plurality of materials. For example, a planchette may be composed of plastic and contain a metal alloy or rare earth metal. Planchettes may be generated that utilize magnetic ink or they may include a magnetic metal.

Various methods of reading or scanning the planchette may be used. For example, SEM (Scanning Electron Microscope) analysis, EEG (Electroencephalography) analysis, TEM (Transmission Electron Microscopy), or other instrumental analysis may be used to read or view the planchette. Planchettes can be detected using technology such as chemical ionization mass spectrometry or ICPMS (Inductively Coupled Plasma Mass Spectrometry). For example, a method of detecting whether an article of manufacture is authentic or genuine comprising: performing chemical ionization mass spectrometry on an article of manufacture; detecting whether a certain frequency of light is detected by a chemic mass spectrometer; if the certain frequency of light is detected, determining that the article of manufacture contains a planchette; determining the article of manufacture is genuine if the article of manufacture is determined to contain a planchette.

A method of scanning a planchette may comprise steps such as: illuminating the planchette with a specific frequency of light (or range of frequencies of light); capturing an image of the planchette with a camera; and storing the image or a hash of the image of the planchette. In some methods, there is no camera or sensor used. Light may be cast or shone onto the planchette to illuminate or reveal parts of the planchette not normally visible with reflected light (e.g., room-base lighting).

Planchettes may be visible to a camera or the naked eye (unassisted human vision) under indirect white light. One or more parts of the planchettes may become illuminated when light of specific frequency is cast on the planchettes. A planchette may be difficult to distinguish (e.g., to see) from the article of manufacture without a specific frequency of light shining on the article of manufacture. A planchette may be difficult to distinguish (e.g., to see) from the article of manufacture without a specific frequency of light shining on the article of manufacture at a specific angle (e.g., oblique lighting, coaxial lighting/retroreflective, or direct lighting). A planchette may be characterized as being invisible if it cannot easily be distinguished from the article of manufacture to which it is attached.

In some configurations, a planchette may comprise an identifier. The identifier may be unique to the planchette, or it may be unique to a set of planchettes. For example, planchettes could contain an identifier to indicate the date of manufacture or the customer purchasing the planchette. The identifier could be a stock keeping unit, a universal product code, a serial number, or alphanumeric code. The identifier may be readable by a human looking at the planchette using reflected or room light. In some configurations, the identifier on the planchette may be specifically designed so that it is not readable by a human without magnification (e.g., a light microscope, magnifying glass, or electronic scanning microscope may be needed to see the identifier). The identifier may be encoded (e.g., a QR Code or barcode) so that it is not directly readable by a human. The planchette and/or the identifier may be configured to be readable only when light at a specific frequency (e.g., 365 nanometers, 800 nanometers, etc.) illuminates the planchette. The planchette may be configured to become visible only when light of specific type (such as coaxial light) or direction (e.g., oblique, transmitted, etc.) is cast onto the planchette.

The identifier of the planchette may be a seed value for determining how to read a second identifier on the planchette. For example, if light of a specific frequency is cast or illuminated onto a planchette, the planchette may display a code. A sensor may be configured to read the code and send the code to a computer. A computer may receive the code, apply a code function to the code to generate a result. The result may be a second frequency of light needed to illuminate another part of the planchette. The code function may be a secret.

The planchette may be configured such that a part of the planchette is visible to a camera or a human when the planchette is illuminated with a first frequency of light or range of frequencies (e.g., white light). The planchette may be configured such that a second part of the planchette becomes visible when a second frequency of light (or second range of frequencies) shines on the planchette. Adding the second frequency of light (or second range of frequencies) may cause the planchette to visibly change shape, because a new portion of the planchette becomes visible when the second frequency of light (or ranges of light) is cast onto the planchette.

In some configurations, the planchettes may comprise circuitry such as RFID or magnetic tags.

The presence or absence of a planchette or a specific type of planchette can be used to determine whether an article of manufacture is genuine or counterfeit. For example: a method of manufacturing an article of manufacture (such as a security card) may comprise: incorporating a first set of planchettes in the security card wherein the first set of planchettes reflect a specific pattern when they are illuminated with a light source at a specific frequency; incorporating a second set of planchettes in the security card wherein the second set of planchettes reflect a different pattern at the same frequency; determining the article of manufacture is a counterfeit if the first and second sets of planchettes is visible. The planchettes may be manufactured such that they must be illuminated at a specific angle (e.g., coaxially) in order for the pattern to be visible or luminesce.

Another example might be: a method of manufacturing an article of manufacture (such as a $100 dollar bill) may comprise: incorporating a first set of planchettes in the dollar bill wherein the first set of planchettes reflect a specific color when they are illuminated with a light source at a specific frequency; incorporating a second set of planchettes in the dollar bill wherein the second set of planchettes reflect a different color at the same frequency; determining the article of manufacture is a counterfeit unless both sets of planchettes are visible. The method may involve a human looking at the dollar bill to determine whether the planchettes are visible. Alternatively, a camera or a sensor may detect whether the planchettes are reflecting back a specific color or pattern. A computer may be programmed to use data from the camera or sensor to decide whether the article of manufacture is genuine or counterfeit.

A security system for an article of manufacture may comprise: a first set of planchettes configured to luminesce when a first frequency of light is cast on the first planchettes; and a second set of planchettes configured to luminesce when a second frequency of light is cast on the first planchettes. The first frequency may be different from the second frequency. The first and second set may comprise one planchette or a plurality of planchettes. The first set of planchettes may be configured so that they only luminesce when light of a first specific frequency is cast on the planchettes. The second set of planchettes may be configured so that they only luminesce when light a second specific frequency is cast on the planchettes.

This disclosure has described several variables germane to the design of planchettes, including shape, visible, and UV substrate color, substrate composition and security fibers, visible and UV surface artwork, and designs for transmitted light inspection. Although each was explored in isolation through the examples in this disclosure, an idealized planchette design (or designs) could take all these factors into consideration simultaneously and combine them in ways that facilitate ergonomic inspection, prevent easy simulation, and respond to several methods of visual and machine inspection, including the many possible combinations of reflected light, UV light, transmitted light, infrared light, angles of illumination and response, cameras, optical filters, sensors and magnification. Inspection can also be by instrumental analysis techniques including, but not limited to, chemical ionization mass spectrometry and chemic mass spectrometry. The security substrate design concepts presented in prior work on combining security fibers are equally applicable to planchettes, such that multiple planchette types with different characteristics and intended for different modes of inspection could be combined in a single substrate. See, e.g., Joel Zlotnick et al., “Strategies for Optimisation of Security Fibres,” https://platform.keesingtechnologies.com/security-fibres-optimisation/, Dec. 11, 2019, and Joel Zlotnick et al., “Strategies for Optimizing Planchettes,” https://platform.keesingtechnologies.com/strategies-for-optimizing-planchettes/, Feb. 23, 2022, the entire disclosures of which are incorporated herein by reference.

### Image Detection Apparatus and Process

The following describes some examples of image detection apparatus and process for authenticating an article of manufacture such as a security document or substrate having planchettes and the like as security features.

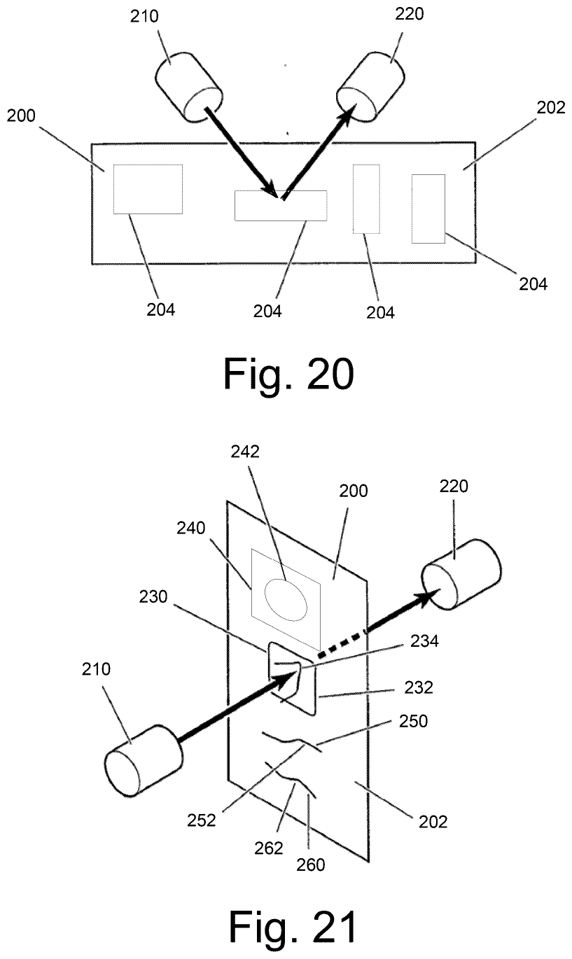

FIG. 20 is a schematic view illustrating image detection of planchettes included in an article of manufacture in a reflective configuration. The article of manufacture 200 may be a substrate 202 having a plurality of planchettes 204. A light source 210 and a detector such as an image detector 220 are disposed on the same side of the substrate 202. The light source 210 illuminates an area of the substrate 202 and the image detector 220 receives reflected radiation from the illuminated area. FIG. 20 shows reflected radiation from a planchette 204 to the image detector 220.

FIG. 21 is a schematic view illustrating image detection of planchettes included in an article of manufacture in a transmissive configuration. In this transmissive or thru-substrate configuration, the light source 210 and the image detector 220 are disposed on opposite sides of the substrate 202. The light source 210 directs radiation through a security feature 230 in the form of a planchette 232 having one or more fibers 234. The substrate 202 has a level of transparency sufficient for the illumination (or the transfer of heat through) to result in a generated sensor response detected by the detector 220. In FIG. 21, the article of manufacture 200 includes another security feature in the form of a planchette 240 having a surface pattern 242 such as a printed pattern. Another security feature 250 is ink 252 printed on the substrate 202. Yet another security feature 260 is fiber 262 in the substrate 202.

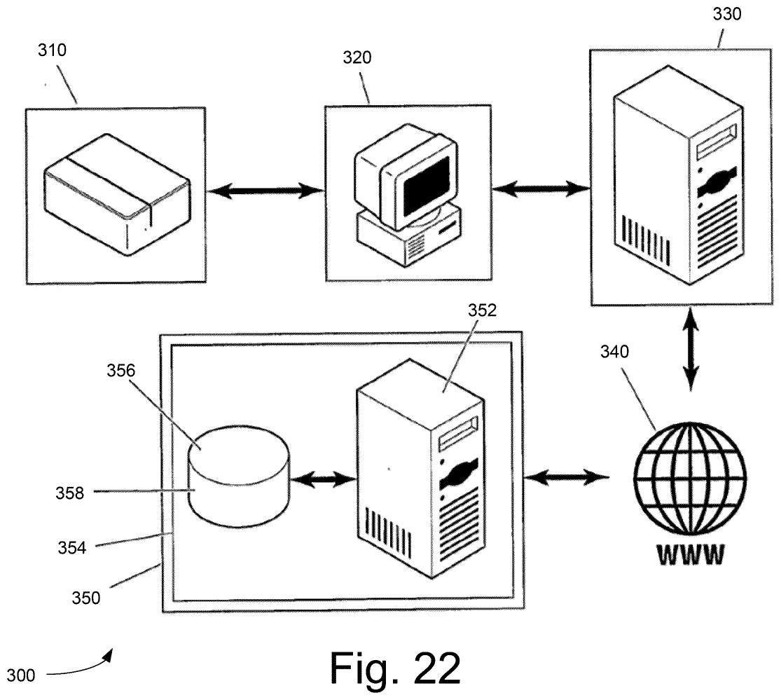

FIG. 22 is a block diagram illustrating an example of an authentication system 300 for determining whether an article of manufacture is genuine utilizing planchettes. A detector such as an image detector 310 may be connected to a client PC (Personal Computer) 320 for detecting a security signature. The detector 310 may transfer the detected security signature to a branch LAN (Local Area Network) server 330, then over a direct link or Internet link or network 340 to a processing center 350. A transaction processing engine 352 of a central processing server 354 of the processing center 350 is operable to compare the detected security signature to one or more security signatures already stored in the central processing server 354 and informs the branch LAN server 330 whether there is a match or not. The central processing server 354 may include a central database 356 stored in a back-end central database system 358, in communication with the transaction processing engine 352 within the central processing server 354 of the processing center 350. A security signature may be digital data, image, pattern, or the like.

The authentication system 300 may be used to determine whether an article of manufacture is genuine. The article of manufacture may be a security document or substrate having security or anticounterfeiting features including one or more planchettes as counterfeiting deterrents, such as those presented in this disclosure. The authentication process may be implemented using machine readable instructions that are executed by any processing or computing systems now known or developed later. The machine-readable instructions may be embodied in software stored on a tangible medium such as a CD-ROM, a floppy disk, a hard drive, a digital versatile disk (“DVD”), or a memory associated with a processor and/or embodied in firmware or dedicated hardware in a well-known manner. Further, persons of ordinary skill in the art will readily appreciate that many other methods of implementing the authentication process may alternatively be used. For example, the order of execution of the process steps may be changed, and/or some of the steps described may be changed, eliminated, or combined.

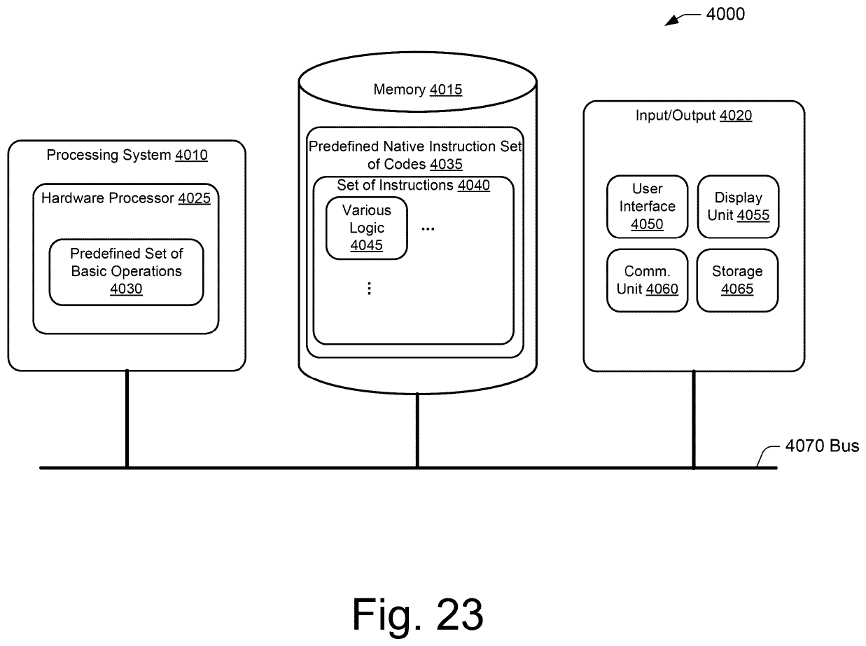

FIG. 23 illustrates an example of a computing system 4000, or apparatus, including logic according to an embodiment. The computer system 4000 includes a processing system 4010 having a hardware processor 4025 configured to perform a predefined set of basic operations 4030 by loading corresponding ones of a predefined native instruction set of codes 4035 as stored in the memory 4015.

Here, the term computer system includes a processing system such as processing system 4010 and a memory such as memory 4015 accessible to the processing system.

The processing system includes at least one hardware processor, and in other examples includes multiple processors and/or multiple processor cores. In one embodiment, a computer system is a standalone device. The processing system in yet another example includes processors from different devices working together. In embodiments, a computer system includes multiple processing systems that communicate cooperatively over a computer network.

The following discussion explains how the logic, that implements the foregoing operations, transforms the hardware processor of computer system 4000 into a specially programmed electronic circuit.

A hardware processor is a complex electronic circuit designed to respond to certain electronic inputs in a predefined manner. The inputs to a hardware processor are stored as electrical charges. The hardware processor interprets the electrical charge of a given memory circuit as having one of two binary values, namely, zero or one.

A given hardware processor has electrical circuitry designed to perform certain predefined operations in response to certain ordered sets of binary values. The electrical circuitry is built of electronic circuits arranged or configured to respond to one set of ordered binary values one way and to another set of ordinary values another way, all in accordance with the hardware design of the particular hardware processor. A given set of ordered binary values to which the hardware processor is designed to respond, in a predefined manner, is an instruction.

The collection of instructions to which a given hardware processor is designed to respond, in a predetermined manner, is the native instruction set of the processor, also referred to as a native instruction set of codes. The native instruction set for one hardware processor may be different from the native instruction set for another hardware processor, depending on their manufacture. To control a given hardware processor, it is necessary to select an instruction or a sequence of instructions from the predefined native instruction set of that hardware processor.

A sequence of codes that a hardware processor is to execute, in the implementation of a given task, is referred to herein as logic. Logic is made up, therefore, not of software but of a sequence of codes or instructions, selected from the predefined native instruction set of codes of the hardware processor, and stored in the memory.

Returning to FIG. 23, the memory 4015 is accessible to the processing system 4010 via the bus 4070. The processing system controls also the input/output unit 4020 via the bus 4070. The input/output unit 4020 includes a user interface controller 4050, a display unit controller 4055, a communications unit controller 4060, and storage controller 4065.

The memory 4015 includes the predefined native instruction set of codes 4035, which constitute a set of instructions 4040 selectable for execution by the hardware processor 4025. In an embodiment, the set of instructions 4040 include logic 4045 representing the central processing server 354 as illustrated in FIG. 22. The instructions in this paragraph do not imply any order of operation or use but are used only for discrimination of one sequence of instructions from another. Such logic 4045 is set forth above in greater detail with respect to the method steps for the various embodiments of offset printing.

The various logic 4045 is stored in the memory 4015 and comprises instructions 4040 selected from the predefined native instruction set of codes 4035 of the hardware processor 4025, adapted to operate with the processing system 4010 to implement the process or processes of the corresponding logic 4045.

The inventive concepts taught by way of the examples discussed above are amenable to modification, rearrangement, and embodiment in several ways. For example, this invention may be applicable in other environments involving other markings different from those in the examples as presented above. Different colors from those described above may be used. The number of printing plates used to form the markings can vary (increase or decrease) from the above examples. The configuration of each of the printing plates can be modified to achieve similar or different functional results or effects. Accordingly, although the present disclosure has been described with reference to specific embodiments and examples, persons skilled in the art will recognize that changes may be made in form and detail without departing from the spirit and scope of the disclosure.

An interpretation under 35 U.S.C. § 112(f) is desired only where this description and/or the claims use specific terminology historically recognized to invoke the benefit of interpretation, such as “means,” and the structure corresponding to a recited function, to include the equivalents thereof, as permitted to the fullest extent of the law and this written description, may include the disclosure, the accompanying claims, and the drawings, as they would be understood by one of skill in the art.

To the extent the subject matter has been described in language specific to structural features or methodological steps, it is to be understood that the subject matter defined in the appended claims is not necessarily limited to the specific features or steps described. Rather, the specific features and steps are disclosed as example forms of implementing the claimed subject matter. To the extent headings are used, they are provided for the convenience of the reader and are not to be taken as limiting or restricting the systems, techniques, approaches, methods, or devices to those appearing in any section. Rather, the teachings and disclosures herein can be combined or rearranged with other portions of this disclosure and the knowledge of one of ordinary skill in the art. It is intended that this disclosure encompass and include such variation.

The indication of any elements or steps as “optional” does not indicate that all other or any other elements or steps are mandatory. The claims define the invention and form part of the specification. Limitations from the written description are not to be read into the claims.

What is claimed is:

1. A security system for an article of manufacture, the security system comprising:
one or more first planchettes included in the article of manufacture and configured to luminesce when a first frequency of light is directed to the one or more first planchettes; and
one or more second planchettes included in the article of manufacture and configured to luminesce when a second frequency of light is directed to the one or more second planchettes;
the first and second planchettes having one or more first planchette substrates each including a first planchette surface having a first UV-reactive microprinting thereon; and one or more second planchette substrates each including a second planchette surface having a second UV-reactive microprinting thereon, the first UV-reactive microprinting being different from the second UV-reactive microprinting.

2. The security system of claim 1,
wherein the first and second planchettes comprise at least one of (i) a plurality of first planchette substrates including a plurality of first planchette surfaces on which a first UV-reactive microprinting is placed, placement of the microprinting being different for each of the plurality of first planchette substrates in relation to a first planchette edge of each first planchette surface of the plurality of first planchette surfaces; or (ii) a plurality of second planchette substrates including a plurality of second planchette surfaces on which a second UV-reactive microprinting is placed, placement of the microprinting being different for each of the plurality of second planchette substrates in relation to a second planchette edge of each second planchette surface of the plurality of second planchette surfaces.

3. The security system of claim 2,
wherein the first and second planchettes comprise (i) the plurality of first planchette substrates including a plurality of first planchette surfaces on which the first UV-reactive microprinting is placed, placement of the microprinting being different for each of the plurality of first planchette substrates in relation to the first planchette edge of each first planchette surface of the plurality of first planchette surfaces; and (ii) the plurality of second planchette substrates including the plurality of second planchette surfaces on which the second UV-reactive microprinting is placed, placement of the microprinting being different for each of the plurality of second planchette substrates in relation to the second planchette edge of each second planchette surface of the plurality of second planchette surfaces; and
wherein the plurality of first planchette surfaces being different from the plurality of second planchette surfaces at least in size or in shape.

4. The security system of claim 1,
wherein (i) the one or more first planchette substrates include at least one of first pigments incorporated therein, first surface printing thereon, or first security fibers incorporated therein; or (ii) the one or more second planchette substrates include at least one of second pigments incorporated therein, second surface printing thereon, or second security fibers incorporated therein; or both (i) and (ii)

5. The security system of claim 1,
wherein (i) the one or more first planchette substrates include first security fibers incorporated therein, the one or more first planchette substrates and the first security fibers having different UV responses; or (ii) the one or more second planchette substrates include second security fibers incorporated therein, the one or more second planchette substrates and the second security fibers having different UV responses; or both (i) and (ii).

6. The security system of claim 1,
wherein (i) the one or more first planchette substrates include first security fibers incorporated therein, the first security fibers containing a first UV-reactive microprinting; or (ii) the one or more second planchette substrates include second security fibers incorporated therein, the second security fibers containing a second UV-reactive microprinting; or both (i) and (ii).

7. The security system of claim 1,
wherein (i) the one or more first planchette substrates each have printed work on a first planchette surface oriented to be invisible in reflected light and be visible in transmitted light; or (ii) the one or more second planchette substrates each have printed work on a second planchette surface oriented to be invisible in reflected light and be visible in transmitted light; or both (i) and (ii).

8. The security system of claim 1,
wherein (i) the one or more first planchette substrates each have printed work on a first planchette surface oriented to be invisible in reflected light and be visible in transmitted light, the one or more first planchette substrates being same in color as the article of manufacture; or (ii) the one or more second planchette substrates each have printed work on a second planchette surface oriented to be invisible in reflected light and be visible in transmitted light, the one or more second planchette substrates being same in color as the article of manufacture; or both (i) and (ii).

9. The security system of claim 1,
wherein the one or more first planchettes are configured to luminesce when the first frequency of light is directed to the one or more first planchettes at a first angle; and
wherein the one or more second planchettes are configured to luminesce when the second frequency of light is directed to the one or more second planchettes at a second angle.

10. The security system of claim 1,
wherein (i) the one or more first planchettes are embedded at different depths of the article of manufacture exhibiting different levels of visibility when the first frequency of light is directed to the first planchettes; or (ii) the one or more second planchettes are embedded at different depths of the article of manufacture exhibiting different levels of visibility when the frequency of light is directed to the second planchettes; or both (i) and (ii).

11. The security system of claim 1,
wherein the one or more first planchettes and the one or more second planchettes have at least one of the following characteristics:
(i) the first frequency is different from the second frequency, the one or more first planchettes are configured not to luminesce when the second frequency of light is directed to the one or more first planchettes, and the one or more second planchettes are configured not to luminesce when the first frequency of light is directed to the one or more second planchettes;
(ii) the one or more first planchettes are configured to luminesce at a first color when the first frequency of light is directed to the one or more first planchettes, and the one or more second planchettes are configured to luminesce at a second color different from the first color when the second frequency of light is directed to the one or more second planchettes; or
(iii) the one or more first planchettes are configured to reflect a first pattern when the first frequency of light is directed to the one or more first planchettes, and the one or more second planchettes are configured to reflect a second pattern when the second frequency of light is directed to the one or more second planchettes.

12. A method of detecting whether an article of manufacture is genuine, the method comprising:
directing a first frequency of light to the article of manufacture;
directing a second frequency of light to the article of manufacture;
detecting whether one or more first planchettes in the article of manufacture luminesce at the first frequency of light and whether one or more second planchettes in the article of manufacture luminesce at the second frequency of light; and whether the first and second planchettes have one or more first planchette substrates each including a first planchette surface having a first UV-reactive microprinting thereon, and one or more second planchette substrates each including a second planchette surface having a second UV-reactive microprinting thereon, the first UV-reactive microprinting being different from the second UV-reactive microprinting.

13. The method of claim 12, further comprising:
determining whether the first and second planchettes comprise at least one of (i) a plurality of first planchette substrates including a plurality of first planchette surfaces on which a first UV-reactive microprinting is placed, placement of the microprinting being different for each of the plurality of first planchette substrates in relation to a first planchette edge of each first planchette surface of the plurality of first planchette surfaces; or (ii) a plurality of second planchette substrates including a plurality of second planchette surfaces on which a second UV-reactive microprinting is placed, placement of the microprinting being different for each of the plurality of second planchette substrates in relation to a second planchette edge of each second planchette surface of the plurality of second planchette surfaces.

14. The method of claim 13, further comprising:
determining whether the first and second planchettes comprise (i) the plurality of first planchette substrates including a plurality of first planchette surfaces on which the first UV-reactive microprinting is placed, placement of the microprinting being different for each of the plurality of first planchette substrates in relation to the first planchette edge of each first planchette surface of the plurality of first planchette surfaces; and (ii) the plurality of second planchette substrates including the plurality of second planchette surfaces on which the second UV-reactive microprinting is placed, placement of the microprinting being different for each of the plurality of second planchette substrates in relation to the second planchette edge of each second planchette surface of the plurality of second planchette surfaces; and
wherein the plurality of first planchette surfaces being different from the plurality of second planchette surfaces at least in size or in shape.

15. The method of claim 12, further comprising:
determining whether (i) the one or more first planchette substrates include at least one of first pigments incorporated therein, first surface printing thereon, or first security fibers incorporated therein; or (ii) the one or more second planchette substrates include at least one of second pigments incorporated therein, second surface printing thereon, or second security fibers incorporated therein; or both (i) and (ii)

16. The method of claim 12, further comprising:
determining whether (i) the one or more first planchette substrates include first security fibers incorporated therein, the one or more first planchette substrates and the first security fibers having different UV responses; or (ii) the one or more second planchette substrates include second security fibers incorporated therein, the one or more second planchette substrates and the second security fibers having different UV responses; or both (i) and (ii).

17. The method of claim 12, further comprising:
determining whether (i) the one or more first planchette substrates include first security fibers incorporated therein, the first security fibers containing a first UV-reactive microprinting; or (ii) the one or more second planchette substrates include second security fibers incorporated therein, the second security fibers containing a second UV-reactive microprinting; or both (i) and (ii).

18. The method of claim 12, further comprising:
determining whether (i) the one or more first planchette substrates each have printed work on a first planchette surface oriented to be invisible in reflected light and be visible in transmitted light; or (ii) the one or more second planchette substrates each have printed work on a second planchette surface oriented to be invisible in reflected light and be visible in transmitted light; or both (i) and (ii).

19. The method of claim 12, further comprising:
determining whether (i) the one or more first planchette substrates each have printed work on a first planchette surface oriented to be invisible in reflected light and be visible in transmitted light, the one or more first planchette substrates being same in color as the article of manufacture; or (ii) the one or more second planchette substrates each have printed work on a second planchette surface oriented to be invisible in reflected light and be visible in transmitted light, the one or more second planchette substrates being same in color as the article of manufacture; or both (i) and (ii).

20. The method of claim 12, further comprising:
determining whether (i) the one or more first planchettes are embedded at different depths of the article of manufacture exhibiting different levels of visibility when the first frequency of light is directed to the first planchettes; or (ii) the one or more second planchettes are embedded at different depths of the article of manufacture exhibiting different levels of visibility when the frequency of light is directed to the second planchettes; or both (i) and (ii).
